(19) United States
(12) Patent Application Publication
(10) Pub. No.: US 2007/0100896 A1
(43) Pub. Date: May 3, 2007

(54) System and method for persistent selection of objects across multiple directories

(75) Inventors: Jessica Jadwiga Peter, Apex, NC (US); Lucinio Santos-Gomez, Durham, NC (US)

Correspondence Address: VAN LEEUWEN & VAN LEEUWEN, P.O. BOX 90609, AUSTIN, TX, 78709-0609, US

(73) Assignee: International Business Machines Corporation

(21) Appl. No.: 11/266,117

(22) Filed: Nov. 3, 2005

(51) Int. Cl. G06F 17/30

(52) U.S. Cl. 707/200

(57) ABSTRACT

A system and method for persistent selection of objects across multiple directories is presented. A user uses a computer system that includes a persistent selection manager to place objects (e.g., files) from multiple directories into a persistent selection state. For each selected object, the persistent selection manager creates a ghost object, which references the original object placed in a permanent selection state, and places the ghost object in a persistent folder. In addition, the persistent selection manager creates a visual overlay for the object that indicates that the object is in the persistent selection state. Once the user is finished placing objects in the persistent selection state, the user may invoke an action on the set of permanently selected objects. The persistent action instructs the persistent selection manager to perform the action on each object corresponding to the ghost objects that are located in the persistent folder.

### BACKGROUND OF THE INVENTION

1. Technical Field

The present invention relates to a system and method for persistent selection of objects across multiple directories. More particularly, the present invention relates to a system and method for selecting objects that are located in separate directories, and invoking a single persistent action on the selected objects.

2. Description of the Related Art

During a typical computer session, a user opens multiple objects, or files. The “type” of objects may be associated with one application or multiple applications. For example, a user may open a Microsoft Excel file and a Microsoft Word file in order to “copy and paste” data from one file to the other file. In addition, the onset of larger display screens and the use of multiple displays allow a user to simultaneously view larger quantities of files.

Even though a user may open multiple objects at once, the objects (e.g., files) are typically stored in different directories, which may be based upon a user's organization preference or an application's requirements. For example, a user may wish to store files based upon the file's corresponding project. As another example, an application may require particular files, such as Java files, to be stored in a specific subdirectory. A challenge found, however, is that existing art requires a user to open objects on an individual basis if the objects are located in different directories. For example, if a user wishes to open “file X” located in “directory C” and “file Y” located in “directory D,” the user must first select directory C and open file X, and then select directory D and open file Y. These redundant steps create a less efficient computer session for the user.

What is needed, therefore, is a system and method for invoking an action on multiple objects that are located in separate directories.

### SUMMARY

It has been discovered that the aforementioned challenges are resolved using a system and method to place objects in a persistent selection state and invoke a single action, such as open, insert, or import, on the selected objects. A user adds objects (e.g., files) to a persistent selection folder, whereby the objects are located in different directories. Once in the persistent folder, the user performs a single action on the persistently selected objects.

A user uses a computer system that includes a persistent selection manager to highlight particular objects on a display. Once the user highlights the objects, the user uses a user interface menu to invoke a “persistent selection.” For example, the user may “right-click” a mouse button which, in turn, displays a pop-up window that allows the user chooses a “select persistently” option.

As a result, the persistent selection manager identifies the highlighted objects, creates a persistent folder, and stores corresponding ghost objects in the persistent folder. The user may then select a different directory and place more objects that are included in the different directory into a persistent selection state. Each of the created ghost objects includes an association to the location of its corresponding object. For example, if the user selected “file X” located in “directory C” and “file Y” located in “directory D,” two ghost objects are stored in the persistent folder, whereby one includes a pointer to “file X” located in “directory C” and the other includes a pointer to “file Y” located in “directory D.”

The user may view a user interface window that displays the persistent folder along with the persistent ghost objects that are included in the folder. In addition, the persistent selection manager sets a persistent selection flag for each of the selected objects that indicate that the objects are persistently selected. In one embodiment, setting the persistent selection flag also includes adding a visual overlay to the objects on the user interface window that identifies the objects are persistently selected.

When the persistent folder includes one or more persistent ghost objects, the user may perform a persistent command. The persistent command may include a persistent action or a persistent de-selection. As an example of a persistent action, the user may perform an import command in order to instruct the persistent selection manager to import each of the persistently selected objects to a particular application. For a persistent de-selection example, the user may wish to remove two out of five objects that are currently included in a persistent selection.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a user selecting multiple objects that are located in multiple directories, and performing an action on the selected objects;

FIG. 2A is a user interface showing a user selecting objects that are located in different directories;

FIG. 2B is a user interface showing a user using a pop-up window to place selected objects into a persistent selection;

FIG. 2C is a user interface showing visual overlays for persistently selected objects, as well as persistent ghost objects that correspond to the persistently selected objects in a persistent folder;

FIG. 3A is a user interface showing a user selecting an object that is part of a persistent selection;

FIG. 3B is a user interface showing a user using a pop-up window to remove an object from a persistent selection;

FIG. 3C is a user interface showing an object that has been removed from a persistent selection;

FIG. 4A is a user interface that is displayed within an application that allows a user to select multiple objects within multiple directories in order to perform a persistent action;

FIG. 4B is a user interface showing a user adding objects to a persistent selection within an application;

FIG. 5 is a high-level flowchart showing steps taken in receiving persistent requests and performing the requests;

FIG. 6 is a flowchart showing steps taken in performing a persistent selection for an object that is located in a directory;

FIG. 7 is a flowchart showing steps taken in performing a persistent action on one or more objects that have corresponding persistent ghost objects located in a persistent folder;

FIG. 8 is a flowchart showing steps taken in performing a persistent de-selection on an object that has been previously persistently selected; and

FIG. 9 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

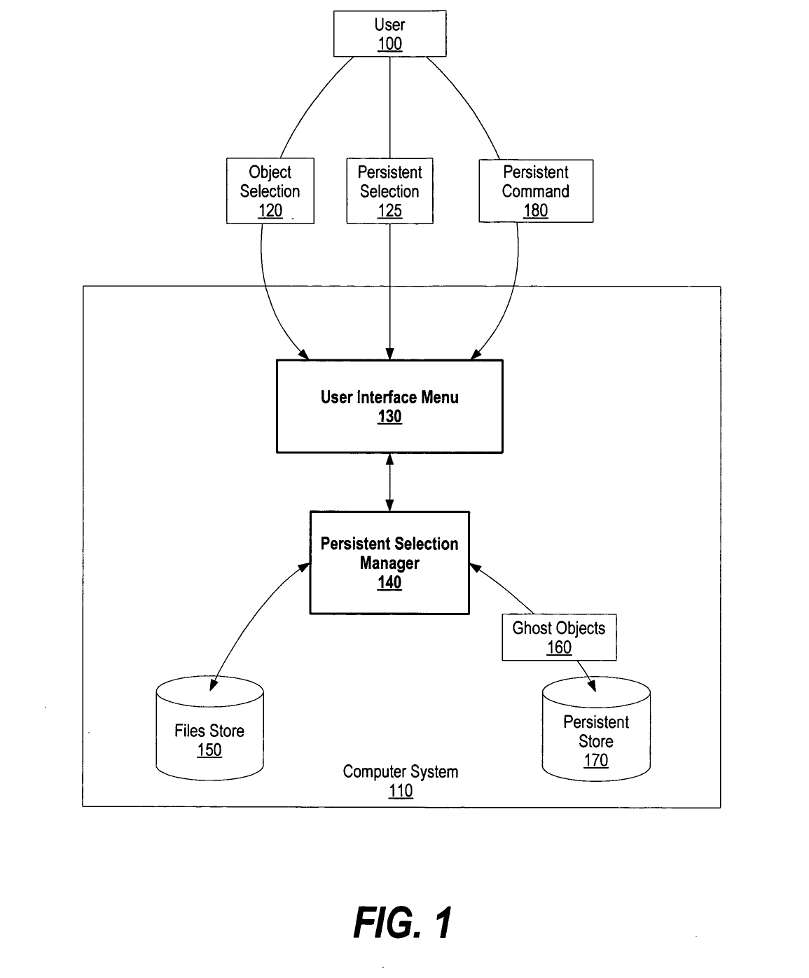

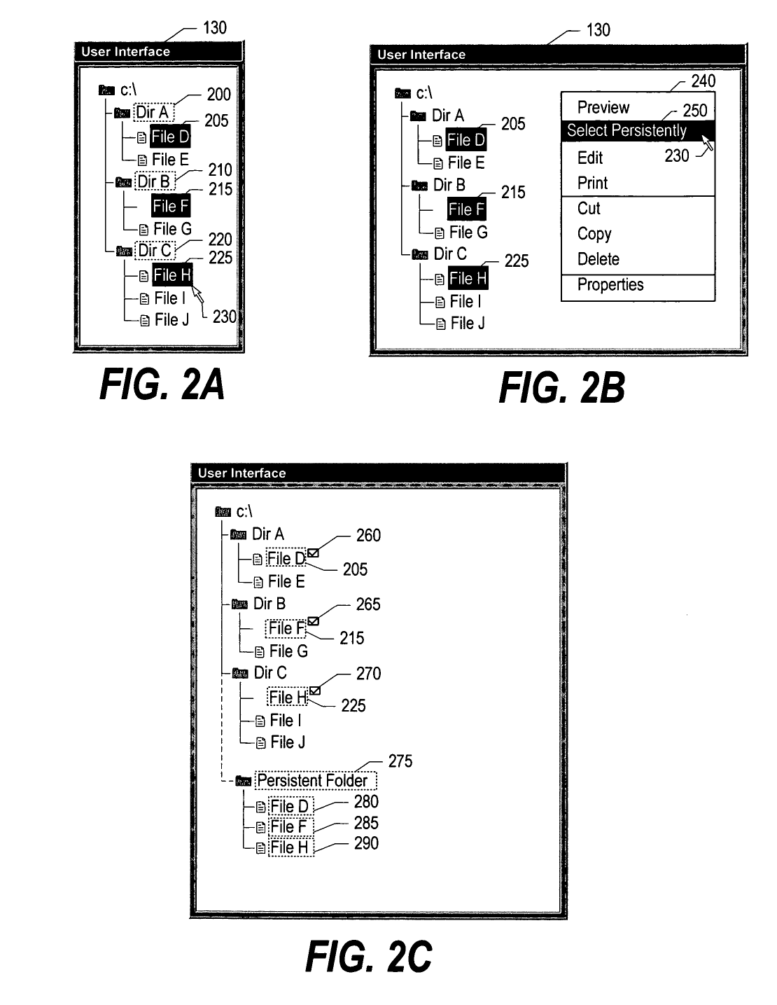

FIG. 1 is a diagram showing a user selecting multiple objects that are located in multiple directories, and performing an action on the selected objects. User 100 uses computer system 110 to persistently select and perform actions on objects. Computer system 110 includes persistent selection manager 140 and user interface menu 130. User interface menu 130 provides a visual interface on a display for user 100 to select objects and perform persistent actions (see FIGS. 2A-C, 3A-C, and 4A-B for further details).

User 100 selects one or more objects included in a directory, which is located in files store 150, via object selection 120. For example, object selection 120 may include a series of mouse commands corresponding to user 100 using a mouse pointer in conjunction with depressing a “Control” key to select multiple objects within a particular directory. Once user 100 selects multiple objects, user 100 invokes persistent selection 125 using user interface menu 130. For example, user 100 may “right-click” a mouse button which, in turn, user interface menu 130 displays a pop-up window. In turn, user 100 chooses a “select persistently” option, such as that shown in Figure 2B. Files store 150 may be stored on a nonvolatile storage area, such as a computer hard drive.

Persistent selection manager 140 detects persistent selection 125, and identifies the objects that were selected via object selection 120. In turn, persistent selection manager creates a persistent folder in persistent store 170 and stores ghost objects 160 in the persistent folder. User 100 may then select a different directory and place more objects that are included in the different directory into the persistent selection state. Each of ghost objects 160 corresponds to one of the selected objects, and includes an association to the location of its corresponding object. For example, if user 100 selected “file X” located in “directory C” and “file Y” located in “directory D,” two ghost objects 160 are stored in the persistent folder, in which one includes a pointer to “file X” located in “directory C” and the other includes a pointer to “file Y” located in “directory D.”

User interface menu 130 displays the persistent folder, along with the persistent ghost objects that are now included in the folder. In addition, persistent selection manager 140 sets a persistent selection flag for each of the selected objects that indicate that the objects are persistently selected. In one embodiment, setting the persistent selection flag also includes adding a visual overlay to the objects on user interface menu 130 that identifies the objects are persistently selected, such as visual overlays 260-270 shown in FIG. 2C.

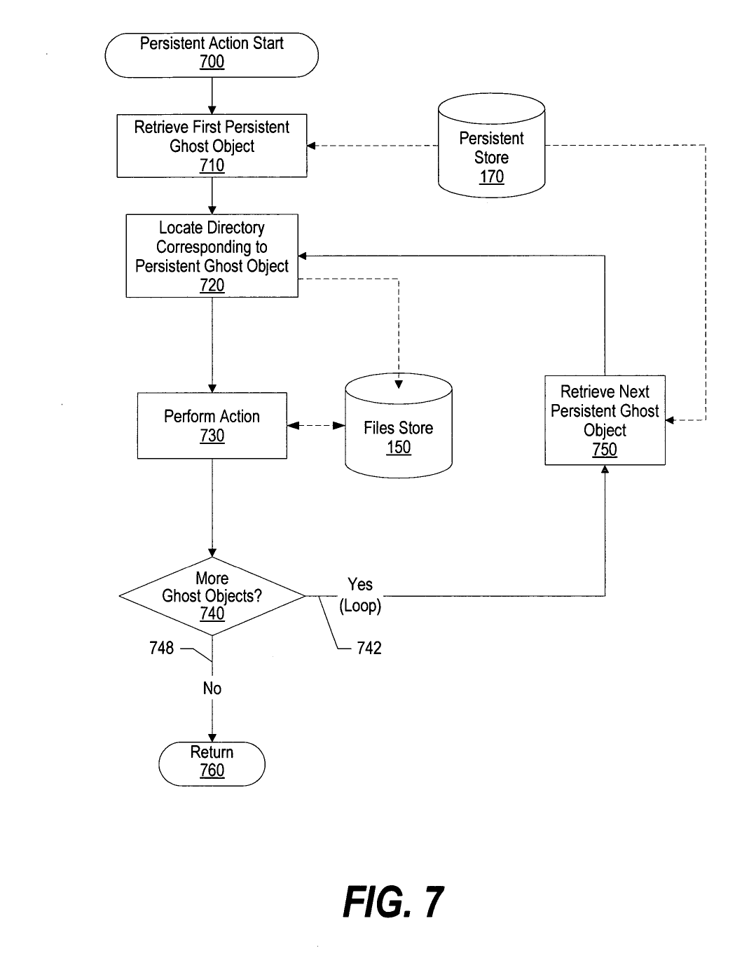

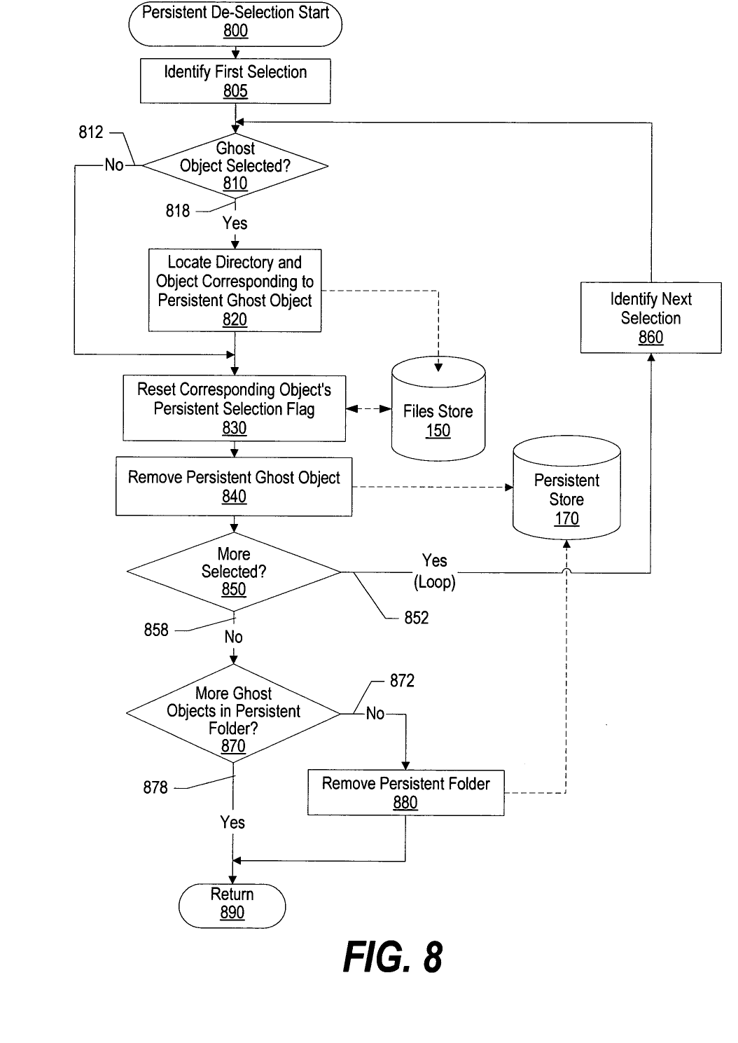

When the persistent folder includes one or more persistent ghost objects, user 100 may perform persistent command 180. Persistent command 180 may include a persistent action or a persistent de-selection. As an example of a persistent action, user 100 may perform an import command in order to instruct persistent selection manager 140 to import each of the persistently selected objects to a particular application (see FIG. 7 and corresponding text for further details). As a persistent de-selection example, user 100 may wish to remove two out of five objects that are currently included in a persistent selection (see FIG. 8 and corresponding text for further details).

FIG. 2A is a user interface showing a user selecting objects that are located in different directories. User interface menu 130 shows a computer system directory structure that includes directories 200, 210, and 220. A user uses pointer 230 to select objects (e.g., files) in one or more of the directories to place in a persistent selection state. FIG. 2A shows that the user selected objects 205, 215, and 225, which are located in directories 200, 210, and 220, respectively. Once the user selects the objects, the user may perform a persistent selection (see FIG. 2B and corresponding text for further details regarding persistent selection). User interface menu 130 is the same as that shown in FIG. 1.

FIG. 2B is a user interface showing a user using a pop-up menu to place selected objects into a persistent selection. Once a user selects one or more objects (see FIG. 2A), the user may add the selected objects to a persistent selection. FIG. 2B shows pop-up menu 240 that includes “select persistently” command 250. The user may perform an action, such as “right-clicking” a mouse button, in order to display pop-up menu 240 on user interface menu 130. The user uses pointer 230 to select command 250 which, as a result, places objects 205, 215, and 225 in a persistent selection state (see FIG. 2C and corresponding text for further details). User interface menu 130 and pointer 230 are the same as that shown in FIG. 2A.

FIG. 2C is a user interface showing visual overlays for persistently selected objects, as well as persistent ghost objects that correspond to the persistently selected objects in a persistent folder. A user persistently selected objects 205, 215, and 225 (see FIGS. 2A and 2B). As such, a persistent selection manager creates persistent folder 275 and places persistent ghost objects 280-290, which corresponds to objects 205, 215, and 225, respectively, into persistent folder 275. Each persistent ghost object includes an association, such as a pointer, to its respective object.

In addition, when the persistent selection manager creates the persistent ghost objects, the persistent selection manager sets a persistent selection flag, which may include adding a visual overlay to each corresponding object, such as visual overlays 260, 265, and 270. As such, a user may identify objects that are persistently selected by either viewing the contents in persistent folder 275 or viewing the visual overlays that are displayed on user interface menu 130. User interface menu 130 is the same as that shown in FIG. 1.

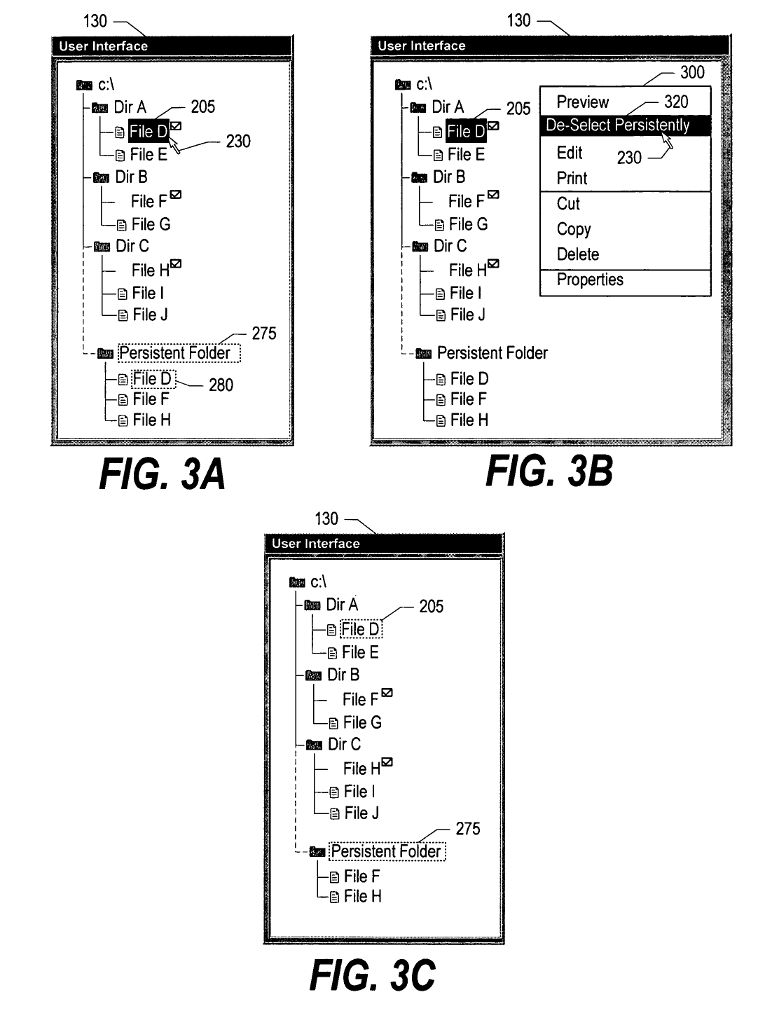

FIG. 3A is a user interface showing a user selecting an object that is part of a persistent selection. The user previously selected objects to include in a persistent selection (see FIGS. 2A-C for further details). User interface menu 130 shows that the user, however, wishes to remove one of the objects from the persistent selection. The user uses pointer 230 to select object 205, such as with a mouse click. Instead of directly selecting object 205, the user may also select persistent ghost object 280 located in persistent folder 275, which is associated with object 205. Once the user selects one or more objects that are part of a persistent selection, the user may perform a persistent de-selection operation (see FIG. 3B and corresponding text for further details). User interface menu 130 is the same as that shown in FIG. 1. Object 205, pointer 230, persistent folder 275, and ghost object 280 are the same as that shown in FIGS. 2A-C.

FIG. 3B is a user interface window showing a user using a pop-up menu to remove an object from a persistent selection. Once a user selects one or more objects (see FIG. 3A), the user may remove the selected objects from a persistent selection. FIG. 3B shows pop-up menu 300 in user interface menu 130 that includes “De-select persistently” command 320. The user may perform an action, such as “right-clicking” a mouse button, in order to display pop-up menu 320. The user uses pointer 230 to select command 320 that, as a result, removes object 205 from the persistent selection (see FIG. 3C and corresponding text for further details). User interface menu 130, object 205, and pointer 230 are the same as that shown in FIG. 3A.

FIG. 3C is a user interface showing an object that has been removed from a persistent selection. Object 205 was part of a persistent selection in FIG. 3A. In FIG. 3B, a user removed object 205 from the persistent selection. As a result, user interface menu 130 shown in FIG. 3C does not include an associated persistent ghost object in persistent folder 275, nor does object 205 include a visual overlay. Therefore, the user may view user interface menu 130 and determine that object 205 is no longer part of the persistent selection. User interface menu 130, object 205, and persistent folder 275 are the same as that shown in FIGS. 3A-3B.

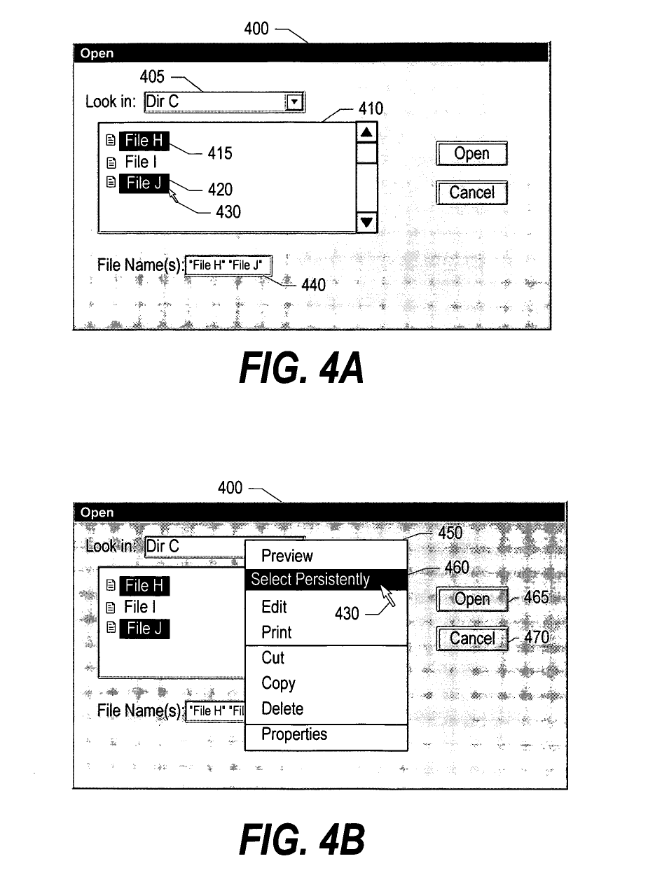

FIG. 4A is a user interface window that is displayed within an application that allows a user to select multiple objects within multiple directories in order to perform a persistent action. For example, a user may be using Microsoft Word and wish to open multiple documents that are located in multiple directories. The user views user interface 400 and selects one of the directories using dropdown 405.

Once one of the directories is selected, the user selects particular objects that are located in the directory and displayed in list box 410. FIG. 4A shows that the user uses pointer 430 to select objects 415 and 420. As a result, the selected object names are displayed in entry field 440 and ready to be added to the persistent selection (see FIG. 4B and corresponding text for further details).

FIG. 4B is a user interface showing a user adding objects to a persistent selection within an application. The user previously selected one or more objects to add to a persistent selection (see FIG. 4A). FIG. 4B shows pop-up menu 450 that includes “select persistently” command 460. The user may perform an action, such as “right-clicking” a mouse button, in order to display pop-up window 460. The user uses pointer 430 to select command 460 that, as a result, places the selected objects in a persistent selection state. The user may continue to select other directories and other objects to place in a persistent selection state. When finished, the user may open the persistently selected objects by selecting command button 465. The user selects command button 470 if the user wishes to cancel the persistent selection and close user interface window 400. User interface window 400 and pointer 430 are the same as that shown in FIG. 4A.

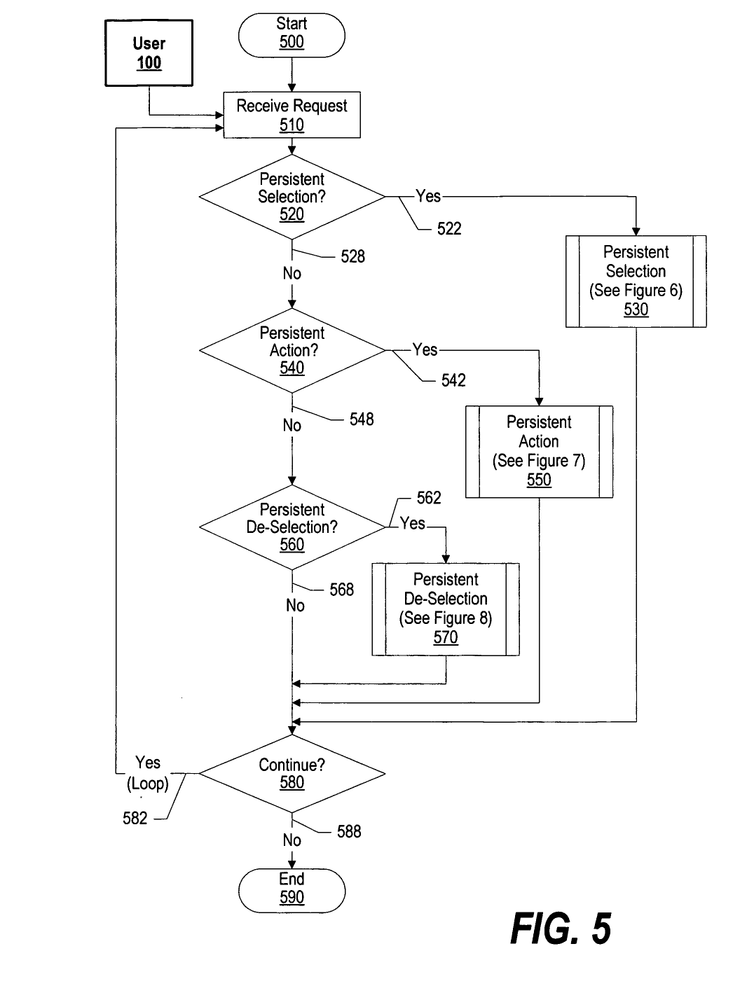

FIG. 5 is a high-level flowchart showing steps taken in receiving persistent requests and performing the requests. Processing commences at 500, whereupon processing receives a request from user 100 at step 510. User 100 is the same as that shown in FIG. 1.

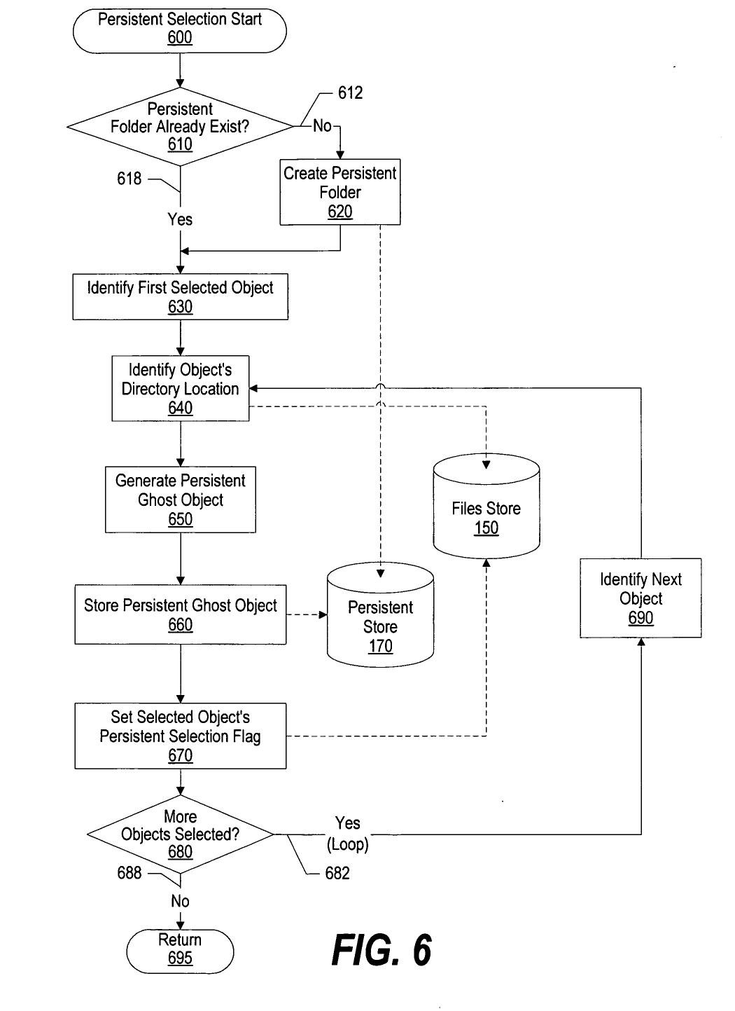

A determination is made as to whether user 100's request is a persistent selection request (decision 520). For example, user 100 may select one or more objects that are located in one or more directories, and then use a pop-up menu, such as that shown in FIG. 2B, to add the selected objects to a persistent selection. If user 100's request is a persistent selection, decision 520 branches to “Yes” branch 522 whereupon processing includes the selected objects in a persistent selection and adds a visual overlay to the selected objects (pre-defined process block 530, see FIG. 6 and corresponding text for further details).

On the other hand, if user 100's request is not a persistent selection, decision 520 branches to “No” branch 528 whereupon a determination is made as to whether user 100's request is a persistent action if a menu action is executed on a persistently selected object (decision 540). A persistent action is an action requested for a persistently selected object. For example, user 100 may have previously persistently selected five files, each located in different directories, and wish to import the five files to a particular application. If user 100's request is a persistent action, decision 540 branches to “Yes” branch 542 whereupon processing performs the persistent action (pre-defined process block 550, see FIG. 7 and corresponding text for further details).

On the other hand, if user 100's request is not a persistent action, decision 540 branches to “No” branch 548 whereupon a determination is made as to whether user 100's request is a persistent de-selection request from a pop-up menu for one or more objects that are currently persistently selected (decision 560). For example, user 100 may have previously persistently selected five files, each located in different directories, and wish to remove one of the files from the persistent selection. If user 100's request is a persistent de-selection request, decision 560 branches to “Yes” branch 562 whereupon processing performs the persistent de-selection (pre-defined process block 570, see FIG. 8 and corresponding text for further details).

On the other hand, if user 100's request is not a persistent de-selection, decision 560 branches to “No” branch 568. A determination is made as to whether to continue receiving requests from user 100 (decision 580). If processing should continue, decision 580 branches to “Yes” branch 582 which loops back to receive and process more requests. This looping continues until processing should terminate, at which point decision 580 branches to “No” branch 588 whereupon processing ends at 590.

FIG. 6 is a flowchart showing steps taken in performing a persistent selection for an object that is located in a directory. Processing commences at 600, whereupon a determination is made as to whether a persistent folder currently exists to store persistent ghost objects (decision 610). For example, a persistent folder may currently exist that includes persistent ghost objects that correspond to previously selected objects. If a persistent folder does not exist, decision 610 branches to “No” branch 612 whereupon processing creates a persistent folder in persistent store 170 (step 620). Persistent store 170 is the same as that shown in FIG. 1, and may be stored on a nonvolatile storage area, such as a computer hard drive.

On the other hand, if a persistent folder already exists, decision 610 branches to “Yes” branch 618 bypassing persistent folder creation steps. At step 630, processing identifies a first object that is selected by a user and, at step 640, processing identifies the object's directory location in files store 150. For example, the user may have selected “file X” located in “directory D.” Files store 150 is the same as that shown in FIG. 1, and may be stored on a nonvolatile storage area, such as a computer hard drive.

At step 650, processing generates a persistent ghost object that is associated with the selected object, and includes a pointer to the selected object. Processing stores the persistent ghost object in the persistent folder located in persistent store 170 at step 660. A user may view the persistent ghost objects in the persistent folder, such as persistent ghost objects 280-290 shown in FIG. 2C.

Processing sets a persistent selection flag for the selected object at step 670 that identifies that the object is persistently selected. Setting the persistent selection flag may also include a step of adding a visual overlay to the selected object in order to inform a user that the object is persistently selected, such as visual overlays 260-270 shown in FIG. 2C.

A determination is made as to whether there are more objects selected in the persistent selection (decision 680). For example, the user may have selected four files that are located in one or more directories for a particular persistent selection. If more objects are selected in the persistent selection, decision 680 branches to “Yes” branch 682 which loops back to identify (step 690) and process the next file. This looping continues until there are no more objects to process, at which point decision 680 branches to No branch 688, whereupon processing returns at 695.

FIG. 7 is a flowchart showing steps taken in performing a persistent action on one or more objects that have corresponding persistent ghost objects located in a persistent folder. For example, a user may have previously persistently selected four files that are located in different directories, and wish to import the files to a particular location.

Processing commences at 700, whereupon processing retrieves a first persistent ghost object from a persistent folder located in persistent store 170 (step 710). The persistent ghost object includes an association to the object placed in a permanently selected state, such as a pointer to that object. Persistent store 170 is the same as that shown in FIG. 1, and may be stored on a nonvolatile storage area, such as a computer hard drive.

At step 720, processing locates the directory in files store 150 where the persistent ghost object's corresponding object resides. For example, the persistent ghost object may include a pointer to “file X” that is located in “directory D.” File store 150 is the same as that shown in FIG. 1, and may be stored on a nonvolatile storage area, such as a computer hard drive.

Processing performs the persistent action, such as an import command, on the persistent ghost object's corresponding object at step 730. Using the example above, processing may import “file X” that is located in “directory D” to an application.

A determination is made as to whether there are more persistent ghost objects located in the persistent folder in which to perform the persistent action (decision 740). If there are more persistent ghost objects in which to perform the persistent action, decision 740 branches to “Yes” branch 742 which loops back to select (step 750) and process the next persistent ghost object. This looping continues until there are no more persistent ghost objects in which to perform the persistent action, at which point decision 740 branches to “No” branch 748 whereupon processing returns at 760.

FIG. 8 is a flowchart showing steps taken in performing a persistent de-selection for an object that has been previously persistently selected. A user selects one or more objects that are included in a persistent selection, and uses a pop-up menu to remove the selected objects from the persistent selection, such as that shown in FIG. 3B.

Processing commences at 800, whereupon processing identifies one of the user's object selections at step 805. The user may select an object itself or a corresponding persistent ghost object that is located in a persistent folder. A determination is made as to whether the selection corresponds to an object or a persistent ghost object (decision 810). If the selection corresponds to a persistent ghost object, decision 810 branches to “Yes” branch 818 whereupon processing locates the object and the object's directory in files store 150 that corresponds to the persistent ghost object (step 820). For example, the persistent ghost object may include a pointer to “file X” that is located in “directory D.” Files store 150 is the same as that shown in FIG. 1, and may be stored on a nonvolatile storage area, such as a computer hard drive.

On the other hand, if the user's selection is a particular object, decision 810 branches to “No” branch 812 bypassing object location steps. At step 830, processing resets the object's persistent selection flag. The resetting step may include removing a visual overlay for indicating that the object is persistently selected. Processing, at step 840, removes the corresponding persistent ghost object from the persistent folder that is located in persistent store 170. Persistent store 170 is the same as that shown in FIG. 1, and may be stored on a nonvolatile storage area, such as a computer hard drive.

A determination is made as to whether the user selected more objects to remove from the persistent selection (decision 850). If more objects should be removed from the persistent selection, decision 850 branches to “Yes” branch 852 whereupon processing loops back to identify (step 860) and process the next selection. This looping continues until no more objects should be removed from the persistent selection, at which point decision 850 branches to “No” branch 858.

A determination is made as to whether the persistent folder includes any more persistent ghost objects (decision 870). For example, the user may have removed all or just a portion of objects from the persistent selection. If the persistent folder does not include any more persistent ghost objects, decision 870 branches to “No” branch 872 whereupon processing removes the persistent folder from persistent store 170 at step 880. On the other hand, if the persistent folder still includes more persistent ghost objects, decision 870 branches to “Yes” branch 878 bypassing persistent folder removal steps. Processing returns at 890.

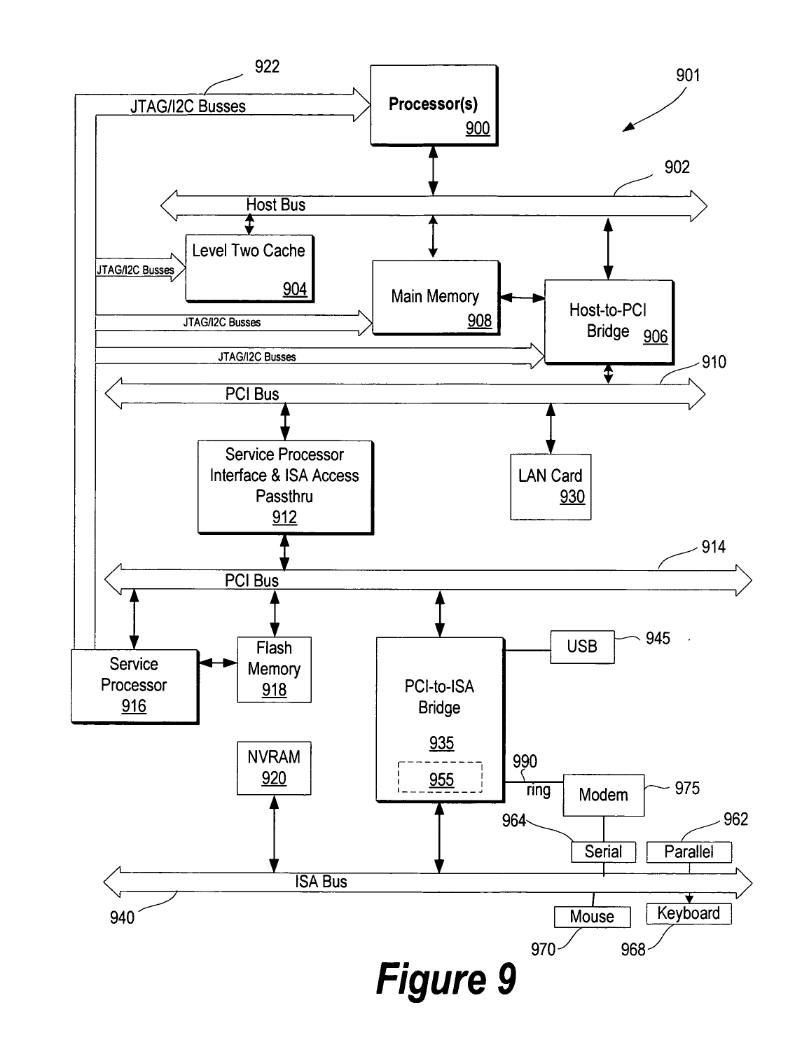

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 995 is connected to serial port 964 and PCI-to-ISA Bridge 935.

While FIG. 9 shows one information handling system that employs processor(s) 900, the information handling system may take many forms. For example, information handling system 901 may take the form of a desktop, server, portable, laptop, notebook, or other form factor computer or data processing system. Information handling system 901 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a first persistent selection that corresponds to a first displayed object that is located in a first directory;
receiving a second persistent selection that corresponds to a second displayed object that is located in a second directory, the second directory different than the first directory;
receiving a persistent command after receiving the first persistent selection and the second persistent selection; and
performing the persistent command on the first displayed object and the second displayed object in response to receiving the persistent command.

2. The method of claim 1 further comprising:
creating, in response to receiving the first persistent selection, a first persistent ghost object that is associated with the first displayed object;
creating, in response to receiving the second persistent selection, a second persistent ghost object that is associated with the second displayed object; and
storing the first persistent ghost object and the second persistent ghost object in a persistent folder located on a nonvolatile storage area.

3. The method of claim 2 further comprising:
selecting, after the storing, the first persistent ghost object and the second persistent ghost object located in the persistent folder;
locating the first displayed object in the first directory using the first persistent ghost object; and
locating the second displayed object in the second directory using the second persistent ghost object.

4. The method of claim 2 further comprising:
receiving a persistent de-selection request corresponding to the first displayed object; and
removing the first persistent ghost object from the persistent folder in response to receiving the persistent de-selection request.

5. The method of claim 4 wherein the de-selection is based upon a user selecting the first persistent ghost object.

6. The method of claim 1 further comprising:
setting a persistent selection flag corresponding to each of the first displayed object and the second displayed object; and
including, in response to setting the flag, a visual overlay on the first displayed object and the second displayed object that is displayed on the display.

7. The method of claim 1 further comprising:
wherein the first persistent selection is invoked by a user manually selecting the first displayed object; and
wherein the second persistent selection is invoked by a user manually selecting the second displayed object.

8. A computer program product stored on a computer operable media, the computer operable media containing instructions for execution by a computer, which, when executed by the computer, cause the computer to implement a method for persistent selection of objects across multiple directories, the method comprising:
receiving a first persistent selection that corresponds to a first displayed object displayed on a display that is located in a first directory;
receiving a second persistent selection that corresponds to a second displayed object displayed on the display that is located in a second directory, the second directory different than the first directory;
receiving a persistent command after receiving the first persistent selection and the second persistent selection; and
performing the persistent command on the first displayed object and the second displayed object in response to receiving the persistent command.

9. The computer program of claim 8 wherein the method further comprises:
creating, in response to receiving the first persistent selection, a first persistent ghost object that is associated with the first displayed object;
creating, in response to receiving the second persistent selection, a second persistent ghost object that is associated with the second displayed object; and
storing the first persistent ghost object and the second persistent ghost object in a persistent folder located on a nonvolatile storage area.

10. The computer program of claim 9 wherein the method further comprises:
selecting, after the storing, the first persistent ghost object and the second persistent ghost object located in the persistent folder;
locating the first displayed object in the first directory using the first persistent ghost object; and
locating the second displayed object in the second directory using the second persistent ghost object.

11. The computer program of claim 9 wherein the method further comprises:
receiving a persistent de-selection request corresponding to the first displayed object; and
removing the first persistent ghost object from the persistent folder in response to receiving the persistent de-selection request.

12. The computer program of claim 11 wherein the de-selection is based upon a user selecting the first persistent ghost object.

13. The computer program of claim 8 wherein the method further comprises:
setting a persistent selection flag corresponding to each of the first displayed object and the second displayed object; and
including, in response to setting the persistent selection flag, a visual overlay on the first displayed object and the second displayed object that is displayed on the display.

14. The computer program of claim 8 wherein the method further comprises:
wherein the first persistent selection is invoked by a user manually selecting the first displayed object; and
wherein the second persistent selection is invoked by a user manually selecting the second displayed object.

15. An information handling system comprising:
one or more displays;
one or more processors;
a memory accessible by the processors;
one or more nonvolatile storage devices accessible by the processors; and
a persistent selection tool for persistently selecting objects across multiple directories, the persistent selection tool being effective to:
receive a first persistent selection that corresponds to a first displayed object displayed on a display that is located in a first directory;
receive a second persistent selection that corresponds to a second displayed object displayed on the display that is located in a second directory, the second directory different than the first directory;
receive a persistent command after receiving the first persistent selection and the second persistent selection; and
perform the persistent command on the first displayed object and the second displayed object in response to receiving the persistent command.

16. The information handling system of claim 15 wherein the persistent selection tool is further effective to:
create, in response to receiving the first persistent selection, a first persistent ghost object that is associated with the first displayed object;
create, in response to receiving the second persistent selection, a second persistent ghost object that is associated with the second displayed object; and
store the first persistent ghost object and the second persistent ghost object in a persistent folder located on one of the nonvolatile storage devices.

17. The information handling system of claim 16 wherein the persistent selection tool is further effective to:
select, after the storing, the first persistent ghost object and the second persistent ghost object located in the persistent folder;
locate the first displayed object in the first directory using the first persistent ghost object; and
locate the second displayed object in the second directory using the second persistent ghost object.

18. The information handling system of claim 16 wherein the persistent selection tool is further effective to:
receive a persistent de-selection request corresponding to the first displayed object; and
remove the first persistent ghost object from the persistent folder in response to receiving the persistent de-selection request.

19. The information handling system of claim 18 wherein the de-selection is based upon a user selecting the first persistent ghost object.

20. The information handling system of claim 15 wherein the persistent selection tool is further effective to:
set a persistent selection flag corresponding to each of the first displayed object and the second displayed object; and
include, in response to setting the persistent selection flag, a visual overlay on the first displayed object and the second displayed object that is displayed on the display.

21. A computer-implemented method comprising:
receiving a first persistent selection that corresponds to a first displayed object displayed on a display that is located in a first directory;
receiving a second persistent selection that corresponds to a second displayed object displayed on the display that is located in a second directory, the second directory different than the first directory;
creating, in response to receiving the first persistent selection, a first persistent ghost object that is associated with the first displayed object;
creating, in response to receiving the second persistent selection, a second persistent ghost object that is associated with the second displayed object;
storing the first persistent ghost object and the second persistent ghost object in a persistent folder located on a nonvolatile storage area;
setting a persistent selection flag corresponding to each of the first displayed object and the second displayed object;
including, in response to setting the persistent selection flag, a visual overlay on the first displayed object and the second displayed object that is displayed on the display;
receiving a persistent command after receiving the first persistent selection and the second persistent selection; and
performing the persistent command on the first displayed object and the second displayed object in response to receiving the persistent command.
